(19) United States
(12) Patent Application Publication
(10) Pub. No.: US 2017/0270139 A1
(43) Pub. Date: Sep. 21, 2017

(54) Location-Based On-The-Spot Image Provision System and Method

(71) Applicant: CM marketing Co., Ltd., Seoul (KR)

(72) Inventors: Hoon Kim, Seoul (KR); Joon Uhn Park, Seoul (KR); Jiseon Kim, Incheon (KR); Jin Wan Park, Goyang-si (KR); Kwang Soo Eum, Gwangmyeong-si (KR); In Kim, Gwangmyeong-si (KR); Dongjun Lee, Seoul (KR)

(21) Appl. No.: 15/072,916

(22) Filed: Mar. 17, 2016

(51) Int. Cl. G06F 17/30; H04W 4/02

(52) U.S. Cl. CPC G06F 17/30241; H04W 4/023; G06F 17/3087; G06F 17/30268; G06F 17/30554

(57) ABSTRACT

The present disclosure relates to a location-based on-the-spot image provision system and method, and more particularly, to such a location-based on-the-spot image provision system and method in which when a consumer terminal requests a provider terminal in the vicinity of a specific location to perform a mission of provision of an on-the-spot image of the specific location and an on-the-spot image of an appropriate location, which has been directly captured by the provider terminal, is provided to the consumer terminal, a point corresponding to the capture and provision of the on-the-spot image is provided to a provider terminal holder, i.e., a person who holds the provider terminal so that a consumer who holds the consumer terminal can rapidly and easily identify the on-the-spot image of the appropriate location even without personally visiting the appropriate location.

### TECHNICAL FIELD

The present disclosure relates to a location-based on-the-spot image provision system and method, and more particularly, to such a location-based on-the-spot image provision system and method in which when a consumer terminal requests a provider terminal in the vicinity of a specific location to perform a mission of provision of an on-the-spot image of the specific location and an on-the-spot image of an appropriate location, which has been directly captured by the provider terminal, is provided to the consumer terminal, a point corresponding to the capture and provision of the on-the-spot image is provided to a provider terminal holder, i.e., a person who holds the provider terminal so that a consumer who holds the consumer terminal can rapidly and easily identify the on-the-spot image of the appropriate location even without personally visiting the appropriate location.

### BACKGROUND ART

Recently, as smartphones (i.e., consumer terminals) are being rapidly spread, the influence of the smartphones is gradually increasing in the life of the public.

A variety of smartphone applications (hereinafter, referred to “apps”) starts to be distributed along with the widespread of the smartphones, in particular, the number of applications is exponentially increasing which provide a location-based service (LBS) using a global positioning system (GPS) built in the smartphones.

The location-based service (LBS) refers to an application system and service that accurately locates a person or an object over a mobile communication network and utilizes the location. Particularly, an application that provides the LBS additionally includes locatability and personalization of smartphones so as to exhibit various possibilities that customized information and a service will be offered from a specific location to an individual user.

The location-based service (LBS) mostly employs the GPS. The GPS is designed to accurately measure the time and the distance from three or more satellites using a GPS receiver such as a smartphone equipped with a GPS module and then accurately acquire the current location information of the GPS receiver according to a triangulation method based on three different distances. The GPS has been widely used in the fields of navigation of aeroplanes, ships, vehicles, etc., and in the field of civil-engineering survey. In addition, the LBS is also provided by a location search system using an electronic map provided by a portal site, for example, such as Google

Such an LBS is applied to a wide variety of fields ranging from a goods provision field such as furniture, computers, foods and the like to a service provision field such as proxy driving, deliveries, quick services, repairs and the like.

As an example of the location-based image provision system, Korean Patent Laid-Open Publication No. 10-2011-0134998 (laid open on Dec. 16, 2011) discloses a location information provision method using a video call, which includes the steps of: identifying a location coordinate based on a GPS signal received from a satellite when there is a request for the video call by a request terminal; marking the location coordinate on map information associated with the identified location coordinate; and creating a map image; and transmitting the created map image to the request terminal.

In addition, Korean Patent Laid-Open Publication No. 10-2011-0131504 (laid open on Dec. 7, 2011) discloses a multi-location information and image provision system using an application, which includes: an interface for generating a location identification request for a plurality of target terminals selected when a location identification application installed on a request terminal runs, and receiving first location information of each of the target terminals from the target terminals in response to the generated location identification request; and a processor for mapping the received first location information onto a map and providing the mapped first location information to a map region within a screen of the request terminal, wherein when receiving video data from a target terminal selected from the plurality of target terminals through the interface, the processor allows the video data to be associated with the selected target terminal and provides the associated video data to a region within the screen of the request terminal, which is different from the map region.

However, the conventional location-based image provision systems as described above entails a problem in that it is merely used for the purpose of the unidirectional monitoring to receive and efficiently manage video information on the current location or surrounding environment of persons who require a care, for example, such as the children or the old persons, and it is difficult for a consumer to, in real-time, identify an on-the-spot image of a specific location which it is desired to identify, such as an image taken at Haeundae Beach in Korea or a waitlist status in front of a specific restaurant.

### DISCLOSURE

### Technical Problem

Accordingly, it is an object of the present disclosure to provide a location-based on-the-spot image provision system and method in which when a consumer terminal requests a provider terminal in the vicinity of a specific location to perform a mission of provision of an on-the-spot image of the specific location and an on-the-spot image of an appropriate location, which is directly captured by the provider terminal, is provided to the consumer terminal, a point corresponding to the capture and provision of the on-the-spot image is provided to a provider terminal holder, i.e., a person who holds the provider terminal so that a consumer who holds the consumer terminal can rapidly and easily identify the on-the-spot image of the appropriate location even without personally visiting the appropriate location.

### Technical Solution

To achieve the above and other objects, in accordance with one embodiment of the present disclosure, there is provided a location-based on-the-spot image provision system including:

a consumer terminal including an input unit for receiving an input of a search keyword for a specific location, provider selection information, and mission performance request information for provision of an on-the-spot image of the specific location, and an output unit for outputting an electronic map of the specific location matched based on the search keyword, information on providers who hold provider terminals located in the vicinity of the specific location, and an on-the-spot image of the specific location provided by a provider terminal, respectively;

a provider terminal including a location measurement unit for providing current location information of the provider terminal, an output unit for outputting the mission performance request information for provision of an on-the-spot image of the specific location, which is transmitted thereto from the consumer terminal, and a camera for capturing the on-the-spot image of the specific location; and

an operator server including a consumer database, a provider database, an electronic map database, a comparison and matching unit for displaying, on the consumer terminal, the electronic map of the specific location matched based on the search keyword for the specific location inputted through the consumer terminal and transmitted thereto from the consumer terminal and the information on providers who hold provider terminals located in the vicinity of the specific location, and an information processing unit for transmitting and receiving the mission performance request information and the on-the-spot image of the specific location between the consumer terminal and the provider terminal.

In accordance with a preferred embodiment of the present disclosure, the operator server may further include a point management unit for processing the mission request of a consumer who holds the consumer terminal and the use and accumulation of a point according to the mission performance of the provider who holds the provider terminal.

In accordance with a preferred feature of the present disclosure, the on-the-spot image of the specific location may be either an image or a moving picture.

To achieve the above and other objects, in accordance with another embodiment of the present disclosure, there is provided a location-based on-the-spot image provision method including:

a first step of receiving a search keyword for a specific location and mission performance request information for provision of an on-the-spot image of the specific location from a consumer terminal;

a second step of receiving current location information of a provider terminal from the provider terminal;

a third step of combining information on providers who hold provider terminals located in the vicinity of the specific location based on the current location information of the provider terminal received from the provider terminal on an electronic map of the specific location matched based on the search keyword by the comparison and matching unit, and transmitting the combined information to the consumer terminal;

a fourth step of receiving provider selection information on a provider selected based on the information on the providers from the consumer terminal and transmitting the mission performance request information to a provider terminal of the selected provider; and

a fifth step of receiving an on-the-spot image of the specific location from the provider terminal 200 of the selected provider and transmitting the on-the-spot image of the specific location to the consumer terminal.

In accordance with a preferred feature of the present disclosure, the method may further include a sixth step of providing a predetermined point to the provider who holds the provider terminal that has provided the on-the-spot image of the specific location.

### Advantageous Effect

The location-based on-the-spot image provision system and method in accordance with the present disclosure is implemented such that when the consumer requests a mission performance for provision of the on-the-spot image of the specific location which he or she desires to identify, information on providers who hold provider terminals located in the vicinity of the specific location is provided based on the location information of the provider terminal 200, and the mission performance request information from the consumer terminal is transmitted to a provider terminal 200 of a provider selected by the consumer so that an on-the-spot image of an appropriate location which has been directly captured by the provider terminal 200 can be provided to the consumer terminal 100. Thus, the consumer can rapidly and easily identify the on-the-spot image of the appropriate location even without personally visiting the appropriate location.

In addition, the location-based on-the-spot image provision system and method in accordance with the present disclosure has an advantage in that the consumer selects a reliable provider and requests a mission performance so that he or she can be provided with a more reliable on-the-spot image of an appropriate location.

Besides, the location-based on-the-spot image provision system and method in accordance with the present disclosure has an advantage in that a point is correspondingly provided to a provider who has performed a mission of provision of an on-the-spot image of a specific location so that a high-reliability mission performance of the provider can be promoted.

### BRIEF DESCRIPTION OF THE DRAWINGS

The above objects, other features and advantages of the present disclosure will become more apparent by describing the preferred embodiments thereof with reference to the accompanying drawings, in which:

FIG. 1 is a schematic block diagram showing the configuration of a location-based on-the-spot image provision system in accordance with an embodiment of the present disclosure;

FIG. 2 is a flow chart showing a location-based on-the-spot image provision method in accordance with an embodiment of the present disclosure; and

FIGS. 3 to 9 are real pictures of a location-based on-the-spot image provision method in accordance with an embodiment of the present disclosure, which is implemented through an application on a portable terminal.

### EXPLANATION ON REFERENCE NUMERALS OF MAIN ELEMENTS IN THE DRAWINGS

100: consumer terminal

110: input unit

120: output unit

200: provider terminal

210: location measurement unit

220: output unit

230: camera

300: operator server

310: consumer database

320: provider database

330: electronic map database

340: comparison and matching unit

350: information processing unit

360: point management unit

### Preferred Embodiments of the Invention

Hereinafter, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

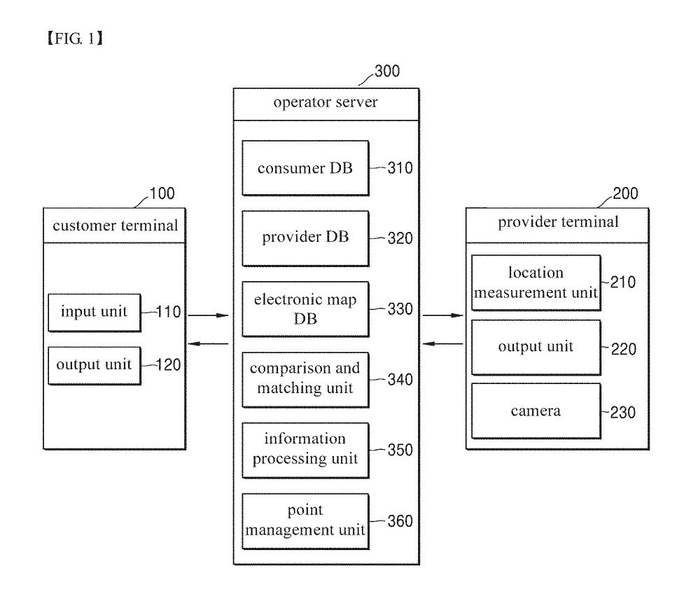

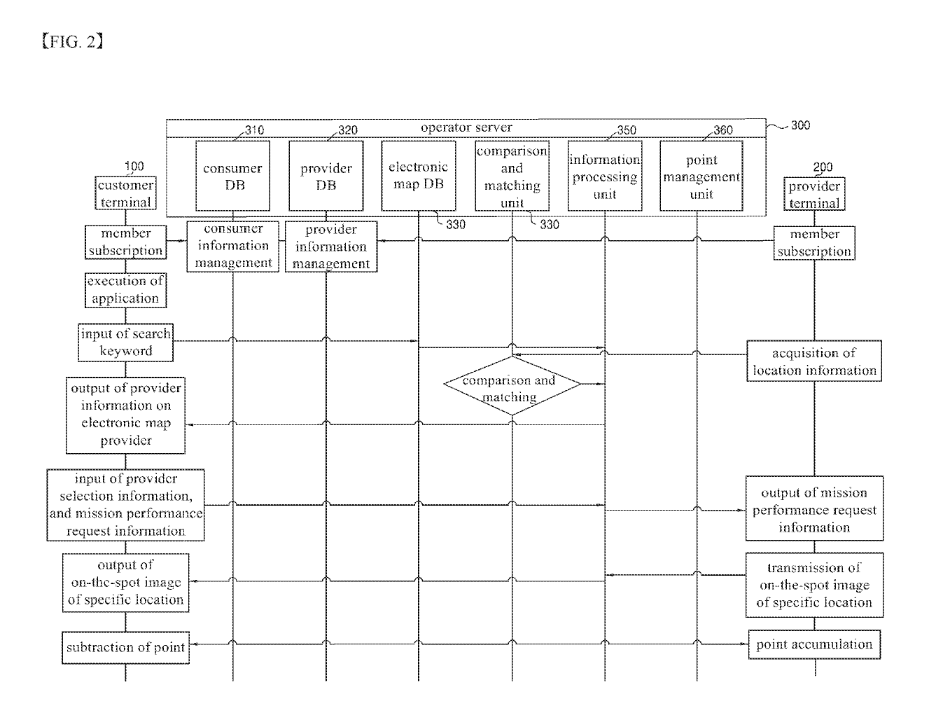

As shown in FIG. 1, a location-based on-the-spot image provision system in accordance with an embodiment of the present disclosure includes a consumer terminal 100 including an input unit 110 for receiving an input of a search keyword for a specific location, provider selection information, and mission performance request information for provision of an on-the-spot image of the specific location, and an output unit 120 for outputting an electronic map of the specific location matched based on the search keyword, information on a provider who holds a provider terminal 200 located in the vicinity of the specific location, and an on-the-spot image of the specific location provided by a provider terminal 200, respectively; a provider terminal 200 including a location measurement unit 210 that provides current location information, an output unit 220 that outputs the mission performance request information for provision of an on-the-spot image of the specific location, which is transmitted thereto from the consumer terminal 100, and a camera 230 that captures the on-the-spot image of the specific location; and an operator server 300 including a consumer database 310, a provider database 320, an electronic map database 330, a comparison and matching unit 340 that displays, on the consumer terminal, an electronic map of the specific location matched based on the search keyword for the specific location inputted through the consumer terminal and transmitted thereto from the consumer terminal 100 and the information on a provider who holds a provider terminal 200 located in the vicinity of the specific location, and an information processing unit 350 that transmits and receives the mission performance request information and the on-the-spot image of the specific location between the consumer terminal 100 and the provider terminal 200.

Herein, the consumer terminal 100 corresponds to a user portable terminal which is carried by a consumer who downloads a specific application from an operator server 300, an app store or the like. The consumer terminal 100 includes the input unit 110 that receives an input of a search keyword for a specific location, provider selection information, and mission performance request information for provision of an on-the-spot image of the specific location, and the output unit 120 that outputs an electronic map of the specific location matched based on the search keyword, information on a provider who holds a provider terminal 200 located in the vicinity of the specific location, and an on-the-spot image of the specific location provided by the provider terminal 200, respectively.

The input unit 110 corresponds to various kinds of input means including an input window for allowing a consumer to input various kinds of information to the consumer terminal 100. A search keyword for a specific location which the consumer desires to currently identify in real time through an image can be inputted to the consumer terminal 100 through the input unit 110. In addition, provider selection information for specifying a provider who desires to perform a mission among providers who hold the provider terminal 200 located in the vicinity of the specific location can be inputted to the consumer terminal 100 by an input method, for example, such as touching or the like. Further, mission performance request information for provision of an on-the-spot image of the specific location which the consumer desires to currently identify in real time through an image can be inputted to the consumer terminal 100 through the input unit 110. The mission performance request information is classified by category to enable input and selection thereof.

The search keyword inputted to the consumer terminal 100 through the input unit 110 may be either a word associated with a specific location, for example, such as ‘Haeundae’, ‘BONO BONO Yeoksam branch’ or the like, or a combination thereof. The mission performance request information inputted to the consumer terminal 100 through the input unit 110 may be either a word associated with a mission at the specific location which the consumer desires to currently identify in real time through an image, for example, such as ‘image of Haeundae Beach’, ‘current waitlist status of ‘BONO BONO Yeoksam branch’ or the like, or a combination thereof.

The output unit 120 corresponds to a display panel that outputs various kinds of information to allow the consumer to identify them through the consumer terminal 100. An electronic map of the specific location matched based on the search keyword and information on a provider who holds the provider terminal 200 located in the vicinity of the specific location can be outputted in a combined state through the output unit 120. In addition, an on-the-spot image of the specific location which is provided by the provider terminal 200 can be outputted through the output unit 120.

The provider terminal 200 corresponds to a user portable terminal which is carried by a provider who downloads a specific application from an operator server 300, an app store or the like. The provider terminal 200 includes the location measurement unit 210 for providing current location information of the provider terminal, the output unit 220 for outputting the mission performance request information which is transmitted thereto from the consumer terminal 100, and a camera 230 for capturing the on-the-spot image of the specific location.

The location measurement unit 210 is a constituent element that receives or measures the current location information of the provider terminal 200, such as a GPS module built in the provider terminal 200 and provides the measured current location information to the operator server 300.

The output unit 220 corresponds to a display panel that outputs various kinds of information to allow the provider to identify them through the provider terminal 200. The mission performance request information which is transmitted to the provider terminal 200 from the consumer terminal 100 is outputted through the output unit 220 so that the provider can identify the mission performance request information which the consumer desires.

The camera 230 is a constituent element that allows the provider to acquire the on-the-spot image of the specific location in response to the mission performance request information of the consumer. The camera 230 is formed as a camera module built in the provider terminal 200. The on-the-spot image of the specific location which is stored by the camera 230 and transmitted by the provider terminal 200 may be either an image or a moving picture

The operator server 300 is a constituent element that interconnects the consumer terminal 100 and the provider terminal 200 through a Web, a Wab, a wireless communication module or the like to perform a location-based on-the-spot image provision service. As shown in FIG. 1, the operator server 300 includes the consumer database 310, the provider database 320, the electronic map database 330, the comparison and matching unit 340 that displays, on the consumer terminal 100, an electronic map of the specific location matched based on the search keyword for the specific location inputted through the consumer terminal and transmitted thereto from the consumer terminal 100 and the information on a provider who holds the provider terminal 200 located in the vicinity of the specific location, and an information processing unit 350 that transmits and receives the mission performance request information and the on-the-spot image of the specific location between the consumer terminal 100 and the provider terminal 200.

The consumer database 310 serves to integratedly manage various kinds of subscription-related information inputted by a consumer who has subscribed as a member through the operator server 300 and downloaded a specific application and various kinds of information (e.g., a use record, etc.) inputted by the consumer during the use of the operator server 300.

The provider database 320 servers to integratedly manage various kinds of subscription-related member information inputted by a provider who has subscribed as a member through the operator server 300 and downloaded a specific application and various kinds of information (e.g., a mission performance record, etc.) inputted by the provider during the use of the operator server 300. The provider database 320 can classify providers by sex or age, or classify them by grade according to the mission performance record. In this case, preferably, information on the classified providers is configured such that different icons or marks according to various kinds of classifications are added or combined to IDs of the providers so that visual differentiation can be provided.

The consumer database 310 and the provider database 320 as described above may be integrated into a member database.

The electronic map database 330 may be an electronic map that is self-constructed by the operator server 300, and may be provided by operating in cooperation with or being extracted from an electronic map search service provided by a portal site, for example, such as Google, Naver or the liker.

The comparison and matching unit 340 is a sort of data processor that displays, on the consumer terminal 100, an electronic map of the specific location matched based on the search keyword for the specific location inputted through the consumer terminal and transmitted thereto from the consumer terminal 100, and at the same time matches the information on a provider who holds the provider terminal 200 located within a certain radius from the specific location based on location information acquired from the provider terminal 200 and displays, on the electronic map, the matched information on the provider who holds the provider terminal 200.

The information processing unit 350 is a constituent element that allows various kinds of information to be transmitted and received between the consumer terminal 100 and the provider terminal 200. In particular, the information processing unit 350 functions to receive the mission performance request information from the consumer terminal 100 for transmission to the provider terminal 200 and at the same time receive the on-the-spot image of the specific location from the provider terminal 200 for transmission to the consumer terminal 100.

In addition, the operator server 300 further includes a point management unit 360 that processes the mission request of a consumer who holds the consumer terminal 100 and the use and accumulation of a point according to the mission performance of the provider who holds the provider terminal 200.

The point management unit 360 serves to deduct a predetermined point from the accumulated points of the consumer and at the same time further accumulate a predetermined point to the accumulated points of the provider when the on-the-spot image of the specific location acquired by the provider in response to the mission performance request information of the consumer is normally provided to the consumer terminal 100.

In addition, a location-based on-the-spot image provision method in accordance with an embodiment of the present disclosure includes:

a first step of receiving a search keyword for a specific location and mission performance request information for provision of an on-the-spot image of the specific location from a consumer terminal 100;

a second step of receiving current location information of a provider terminal 200 from the provider terminal 200;

a third step of combining information on providers who hold provider terminals located in the vicinity of the specific location based on the current location information of the provider terminal 200 received from the provider terminal 200 on an electronic map of the specific location matched based on the search keyword by the comparison and matching unit 340, and transmitting the combined information to the consumer terminal 100;

a fourth step of receiving provider selection information on a provider selected based on the information on the providers from the consumer terminal 100 and transmitting the mission performance request information to a provider terminal 200 of the selected provider; and

a fifth step of receiving an on-the-spot image of the specific location from the provider terminal 200 of the selected provider and transmitting the on-the-spot image of the specific location to the consumer terminal 100.

In addition, the location-based on-the-spot image provision method in accordance with an embodiment of the present disclosure further includes a sixth step of providing a predetermined point to the provider who holds the provider terminal 200 that has provided the on-the-spot image of the specific location to the consumer terminal 10.

First, a consumer and a provider have an access to the operator server 300 to get a member subscription, and download a specific application from the operator server 300 or an app store through the consumer terminal 100. Subscription-related information inputted by the consumer who has subscribed as a member is stored in the consumer database 310, and subscription-related information inputted by the provider who has subscribed as a member is stored in the provider database 320. The consumer database 310 and the provider database 320 may be integrated into a member database.

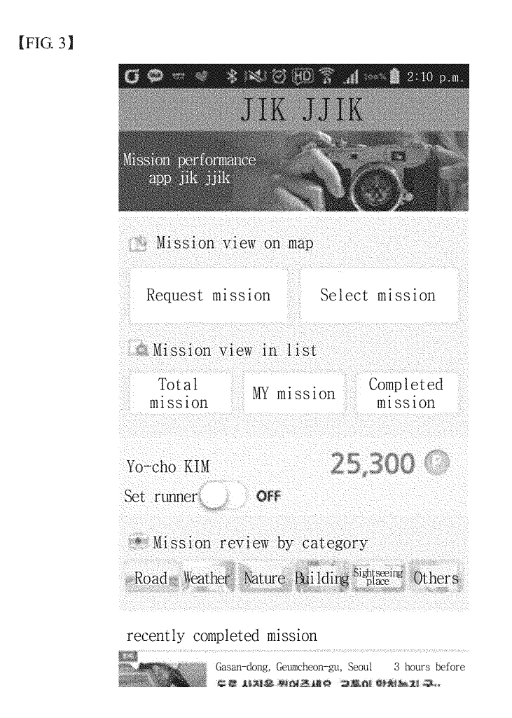

In the case where the consumer desires to identify an on-the-spot image of a specific location in real time for a specific purpose, when he or she runs the specific application downloaded through the consumer terminal 100, a main screen is displayed through the output unit 120 of the consumer terminal 100 as shown in FIG. 3.

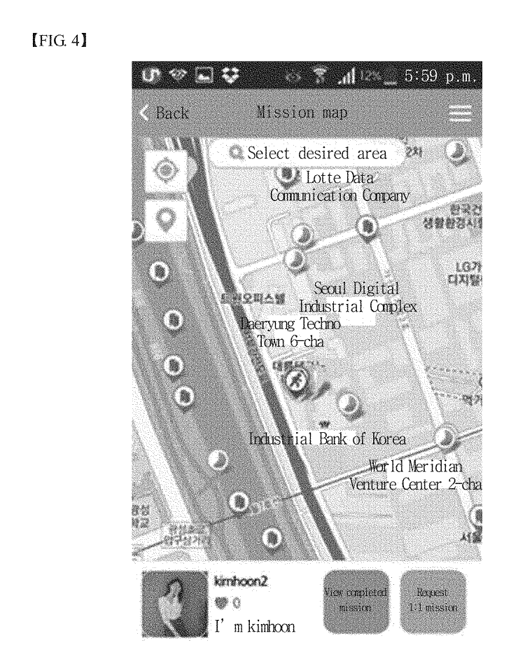

Subsequently, when the consumer clicks on a mission request icon on the main screen and then inputs a search keyword related to a specific location, for example, such as ‘Gasan-dong, Geumcheon-gu, Seoul ’, an electronic map of the specific location matched based on the search keyword for the specific location inputted through the consumer terminal 100 and information on providers who hold provider terminals 200 located within a certain radius from the specific location are displayed on the output unit 120 of the consumer terminal 100 based on the location information acquired from the provider terminal 200 as shown in FIG. 4.

In this case, the information on the matched providers may further include a sex, an age, a grade classified according to the mission performance. Such additional information may be represented such that different icons according to various kinds of classifications are added or combined to IDs of the providers.

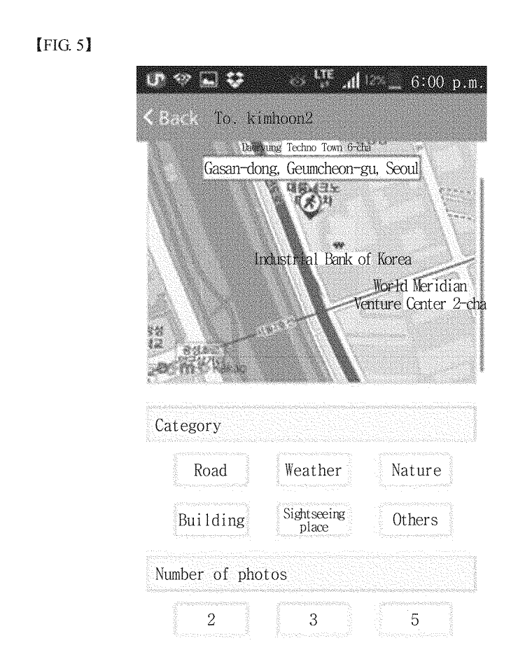

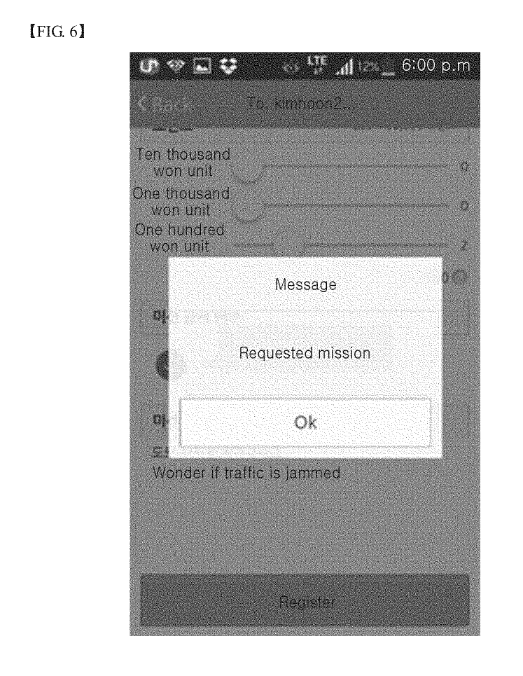

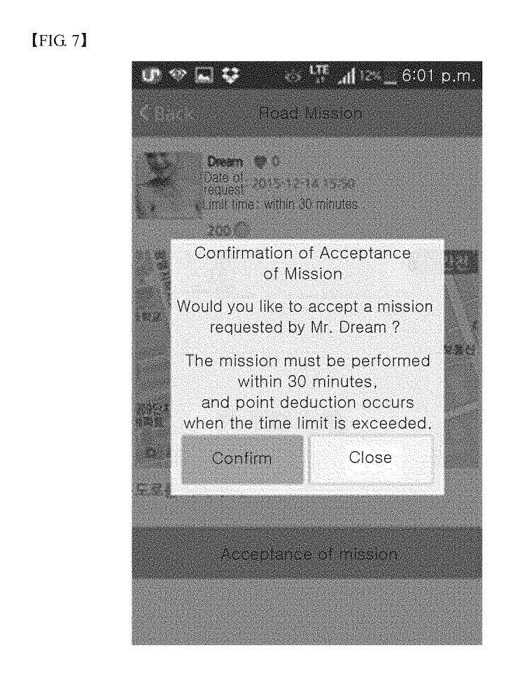

Next, when the consumer selects a specific provider based on the information of providers and then requests a mission performance along with the input of mission performance request information as shown in FIGS. 5 and 6, the output unit 220 of the provider terminal 200 displays that a specific mission from the consumer has been accepted by the information processing unit 250 as shown in FIG. 7.

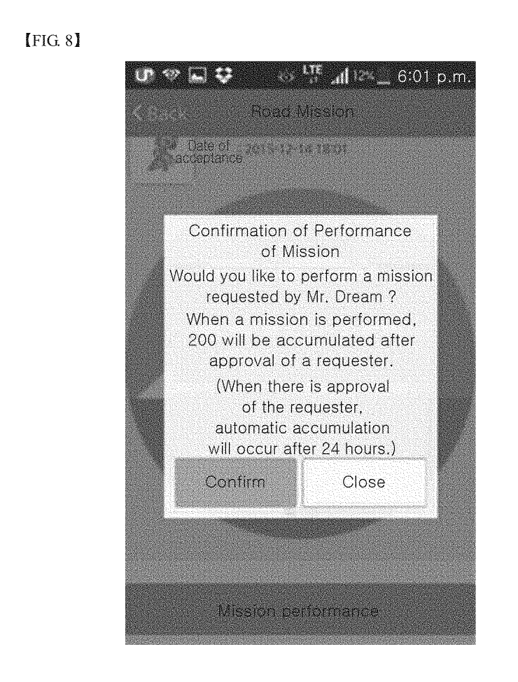

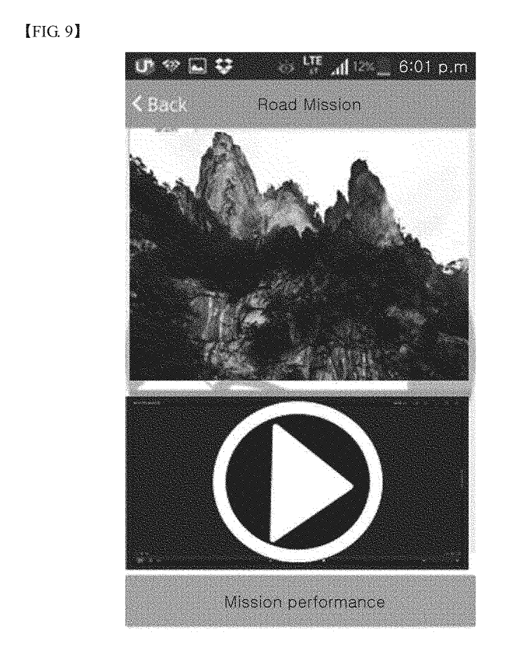

Thereafter, the provider who holds the provider terminal 200 confirms the mission performance request as show in FIG. 7, and expresses a mission performance intention by clicking on a confirmation button as shown in FIG. 8. Then, the provider captures an on-the-spot image of a specific location which the consumer desires to currently identify in real time using the camera 230 of the provider terminal 200 and then transmits the captured on-the-spot image to the operator server 300 through an appropriate application. At this time, the information processing unit 350 of the operator server 300 receives the captured on-the-spot image from the provider terminal 200 and then transmits an appropriate image to the consumer terminal 100. Therefore, the consumer who holds the consumer terminal 100 can promptly identify the appropriate image as show in FIG. 9. In this case, the on-the-spot image of the specific location may be one or more images or moving pictures.

In the case where the on-the-spot image of the specific location, which is acquired by the provider in response to the mission performance request information, is normally provided to the consumer terminal 100, a predetermined point is deducted from the accumulated points of the consumer, and at the same time a predetermined point is further accumulated to the accumulated points of the provider by the point management unit 360 of the operator server 300. When the provider does not perform the mission within a predetermined time period, a predetermined point may be deducted from the accumulated points of the provider.

The location-based on-the-spot image provision system and method in accordance with the present disclosure as described above is implemented such that when the consumer requests a mission performance for provision of the on-the-spot image of the specific location which he or she desires to identify, information on providers who hold provider terminals located in the vicinity of the specific location is provided based on the location information of the provider terminal 200, and the mission performance request information from the consumer terminal is transmitted to a provider terminal 200 of a provider selected by the consumer so that an on-the-spot image of an appropriate location which has been directly captured by the provider terminal 200 can be provided to the consumer terminal 100. Thus, the consumer can rapidly and easily identify the on-the-spot image of the appropriate location even without personally visiting the appropriate location.

Therefore, when the consumer requests a specific provider located in the vicinity of an appropriate location to perform a mission of provision of an on-the-spot image of a specific location which he or she desires to identify, for example, such as information on an image currently taken at Haeundae Beach or a waitlist status in front of a specific restaurant using the location-based on-the-spot image provision system and method in accordance with the present disclosure, the on-the-spot image of the specific location, which has been captured by the provider, can be provided to and identified by the consumer.

In addition, the location-based on-the-spot image provision system and method in accordance with the present disclosure has an advantage in that the consumer selects a reliable provider and requests a mission performance from the provider so that he or she can be provided with a more reliable on-the-spot image of an appropriate location and in that a point is correspondingly provided to a provider who has performed a mission of provision of an on-the-spot image of a specific location so that a high-reliability mission performance of the provider can be promoted.

While the present disclosure has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present disclosure. Therefore, the true technical scope of the present disclosure should not be defined by the above-mentioned embodiments but should be defined by the appended claims and equivalents thereof.

What is claimed is:

1. A location-based on-the-spot image provision system comprising:
a consumer terminal including an input unit for receiving an input of a search keyword for a specific location, provider selection information, and mission performance request information for provision of an on-the-spot image of the specific location, and an output unit for outputting an electronic map of the specific location matched based on the search keyword, information on providers who hold provider terminals located in the vicinity of the specific location, and an on-the-spot image of the specific location provided by a provider terminal, respectively;
a provider terminal including a location measurement unit for providing current location information of the provider terminal, an output unit for outputting the mission performance request information for provision of an on-the-spot image of the specific location, which is transmitted thereto from the consumer terminal, and a camera for capturing the on-the-spot image of the specific location; and
an operator server including a consumer database, a provider database, an electronic map database, a comparison and matching unit for displaying, on the consumer terminal, the electronic map of the specific location matched based on the search keyword for the specific location inputted through the consumer terminal and transmitted thereto from the consumer terminal and the information on providers who hold provider terminals located in the vicinity of the specific location, and an information processing unit for transmitting and receiving the mission performance request information and the on-the-spot image of the specific location between the consumer terminal and the provider terminal.

2. The location-based on-the-spot image provision system according to claim 1, wherein the operator server further includes a point management unit for processing the mission request of a consumer who holds the consumer terminal and the use and accumulation of a point according to the mission performance of the provider who holds the provider terminal.

3. The location-based on-the-spot image provision system according to claim 1, wherein the on-the-spot image of the specific location is either an image or a moving picture.

4. A location-based on-the-spot image provision method comprising:
a first step of receiving a search keyword for a specific location and mission performance request information for provision of an on-the-spot image of the specific location from a consumer terminal;
a second step of receiving current location information of a provider terminal from the provider terminal;
a third step of combining information on providers who hold provider terminals located in the vicinity of the specific location based on the current location information of the provider terminal received from the provider terminal on an electronic map of the specific location matched based on the search keyword by the comparison and matching unit, and transmitting the combined information to the consumer terminal;
a fourth step of receiving provider selection information on a provider selected based on the information on the providers from the consumer terminal and transmitting the mission performance request information to a provider terminal of the selected provider; and
a fifth step of receiving an on-the-spot image of the specific location from the provider terminal 200 of the selected provider and transmitting the on-the-spot image of the specific location to the consumer terminal.

5. The location-based on-the-spot image provision method according to claim 4, further comprising a sixth step of providing a predetermined point to the provider who holds the provider terminal that has provided the on-the-spot image of the specific location to the consumer terminal.
